(19) United States
(12) Patent Application Publication
(10) Pub. No.: US 2003/0225219 A1
(43) Pub. Date: Dec. 4, 2003

(54) Process for the preparation of ABS compositions with improved toughness properties

(76) Inventors: Herbert Eichenauer, Dormagen (DE); Stefan Moss, Haan (DE)

Correspondence Address: BAYER POLYMERS LLC, 100 BAYER ROAD, PITTSBURGH, PA, 15205, US

(21) Appl. No.: 10/442,459

(22) Filed: May 21, 2003

(30) Foreign Application Priority Data
May 28, 2002 (DE) 10223646.1

(51) Int. Cl. C08F 2/00

(52) U.S. Cl. 525/243

(57) ABSTRACT

A process for preparing a thermoplastic molding composition of the ABS type is described. The process includes: (A) forming at least one graft rubber A) using a rubber latex having a d₅₀ value of <200 nm; (B) forming at least one graft rubber B) using a rubber latex having a d50 value of ≧200 nm; and forming a rubber-free thermoplastic polymer resin C). The method further includes: (D) forming precipitates of graft rubbers A) and B); (E) de-watering the precipitates to form water moist powders of graft rubbers A) and B); and mixing the water-moist powders of graft rubbers A) and B) with polymer C) in a kneader reactor. Graft rubbers A) and B) may be prepared separately or in a single step. The content in wt. % of rubber originating from graft rubber component A) based on the total amount of rubber in the molding composition is at least 5 wt. % lower than the content of rubber in wt.% originating from graft rubber component B), in each case based on 100 parts by wt. of graft rubber.

### CROSS REFERENCE TO RELATED PATENT APPLICATION

The present patent application claims the right of priority under 35 U.S.C. §119 (a)-(d) of German Patent Application No. 102 23 646.1, filed May 28, 2002.

### FIELD OF THE INVENTION

The present invention relates to a process for the preparation of bi-, tri- or multimodal ABS compositions with improved mechanical properties.

ABS compositions are two-phase plastics of monomers which form a thermoplastic copolymer resin, e.g. styrene and acrylonitrile, and at least one graft polymer which is obtainable by polymerization of one or more resin-forming monomers, e.g. those mentioned above, in the presence of a rubber, e.g. butadiene homo- or copolymers, as the graft base.

ABS compositions have already been employed in large amounts for many years as thermoplastic resins for the production of all types of moldings.

The term ABS compositions (or compositions of the ABS type) here has been extended in the course of time beyond compositions which substantially comprise acrylonitrile, butadiene and styrene, and in the context of the present invention also include those compositions in which these constituents have been replaced entirely or in part by analogous constituents. Examples of analogous constituents for acrylonitrile are e.g. methacrylonitrile, ethacrylonitrile, methyl methacrylate or N-phenylmaleimide. Examples of analogous constituents for styrene are e.g. α-methylstyrene, chlorostyrene, vinyltoluene, p-methylstyrene or tert-butylstyrene. An analogous constituent for butadiene is e.g. isoprene.

In addition to the direct preparation of ABS compositions by bulk or solution polymerization processes, the preparation of ABS compositions using graft rubbers prepared by emulsion polymerization is still of great importance, in particular in the production of high-gloss moldings.

The preparation of such ABS compositions which are suitable as molding compositions is conventionally carried out by compounding the graft rubber powders with styrene/acrylonitrile copolymer resins or other suitable thermoplastic resin components on units such as e.g. internal kneaders or extruders or screw machines.

The graft latex prepared by emulsion polymerization is conventionally worked up via the working steps of precipitation, washing and mechanical and/or thermal drying. However, thermal drying of a graft latex in the solid phase requires a high consumption of energy and, because of the dust explosion risk associated with the drying, is carried out in specially equipped dryers, which severely limits the profitability of this process.

In addition to the frequently used combination of powder drying and subsequent compounding with the thermoplastic, processes for impact modification of thermoplastics which are based on direct incorporation of rubber latices which have been only partly dewatered mechanically into thermoplastic polymers on a screw extruder are already described in the prior art (see e.g. DE 20 37 784). Further-developed extruder processes are described in the European laid-open specifications EP 0 534 235 A1, EP 0 665 095 A1, EP 0 735 077 A1, EP 0 735 078 A1, EP 0 734 825 A1 and EP 0 734 826 A1.

A particular disadvantage of these processes is the high stress on the rubber/thermoplastic mixture because of the high shear rate of up to 1,000 s⁻¹ in screw extruders. Another disadvantage of the process mentioned last is its multi-stage process procedure, since water is first withdrawn and mixing of the melt and finally, in a further step, residual degassing of the polymer are then carried out. Since the energy in screw machines is substantially introduced as mechanical energy via the screw shafts, it is moreover possible to only a limited degree to control the introduction of energy via supply of heat and to avoid thermal stress on the polymers.

A novel method for the preparation of ABS compositions using emulsion graft rubbers is described in EP-A 867 463. In this, the ABS composition is produced by mixing moist graft rubber polymers with thermoplastic resins in molten form (e.g. styrene/acrylonitrile copolymer) under specific reaction conditions in a kneader reactor.

However, in the preparation of bi-, tri- or multimodal ABS compositions using the process described in EP-A 867 463, it has been found that ABS products with an inadequate toughness, in particular an inadequate notched impact strength, result during the preparation of bimodal systems, such as e.g. according to example 1 in EP-A 867 463.

### SUMMARY OF THE INVENTION

There was therefore the object of providing a process for the preparation of bi-, tri- or multimodal ABS compositions with improved mechanical properties, in particular improved notched impact strength, using a kneader reactor.

The object is achieved according to the invention by a process in which, in the preparation of the bi-, tri- or multimodal ABS systems in a kneader reactor, specific particle sizes and ratios of amounts of the rubber polymers employed for synthesis of the graft rubber polymers and specific compositions of the graft rubber polymers have been maintained.

In accordance with the present invention, there is provided a process of preparing a thermoplastic molding composition of the ABS type comprising:

A) forming at least one graft rubber A) by emulsion polymerization of,

(i) at least two monomers selected from the group consisting of styrene, α-methylstyrene, acrylonitrile, methacrylonitrile, methyl methacrylate and N-phenylmaleimide,

in the presence of,

(ii) at least one rubber latex, the average particle diameter d₅₀ of the rubber latex being <200 nm;

B) forming at least one graft rubber B) by emulsion polymerization of,

(i) at least two monomers selected from the group consisting of styrene, α-methylstyrene, acrylonitrile, methacrylonitrile, methyl methacrylate and N-phenylmaleimide,

in the presence of

(ii) at least one rubber latex, the average particle diameter d₅₀ of the rubber latex being ≧200 nm;

C) forming at least one rubber-free thermoplastic polymer resin C) by free-radical polymerization of at least two monomers selected from the group consisting of styrene, α-methylstyrene, acrylonitrile, methacrylonitrile, methyl methacrylate and N-phenylmaleimide;

D) forming precipitates of each of graft rubbers A) and B);

E) dewatering the precipitates of graft rubbers A) and B) to form water-moist powders of graft rubbers A) and B), each water-moist powder independently having a water content of 1 to 50 percent by weight, based on total weight of the water-moist powder; and

F) mixing the water-moist powders of graft rubbers A) and B) with said rubber-free thermoplastic polymer resin C) in a kneader reactor,

wherein

a) the graft rubber components A) and B) are each prepared in separate emulsion polymerization reactions,

b) the content in wt. % of the rubber originating from graft rubber component A) based on the total amount of rubber in the molding composition is at least 5 wt. %, preferably at least 7.5 wt. %, and particularly preferably at least 10 wt. % lower than the content of rubber in wt. % originating from graft rubber component B), in each case based on 100 parts by wt. of graft rubber, and

c) the average particle diameter d₅₀ of the total of all the rubber particles contained in the molding composition has a value of ≦300 nm, preferably ≦280 nm, and particularly preferably ≦260 nm.

In accordance with the present invention, there is further provided a process for preparing a thermoplastic molding composition of the ABS type comprising:

A) forming at least one graft rubber by emulsion polymerization of,

(i) at least two monomers selected from the group consisting of styrene, α-methylstyrene, acrylonitrile, methacrylonitrile, methyl methacrylate and N-phenylmaleimide,

in the presence of

(ii) at least one rubber latex, the average particle diameter d₅₀ of the rubber latex being <300 nm;

B) forming at least one graft rubber by emulsion polymerization of,

(i) at least two monomers selected from the group consisting of styrene, α-methylstyrene, acrylonitrile, methacrylonitrile, methyl methacrylate and N-phenylmaleimide,

in the presence of

(ii) at least one rubber latex, the average particle diameter d₅₀ of the rubber latex being ≧300 nm;

C) forming at least one rubber-free thermoplastic polymer resin by free-radical polymerization of at least two monomers selected from the group consisting of styrene, α-methylstyrene, acrylonitrile, methacrylonitrile, methyl methacrylate and N-phenylmaleimide;

D) forming precipitates of graft rubbers A) and B);

E) dewatering the precipitates of graft rubbers A) and B) to form a water-moist powder of graft rubbers A) and B), said water-moist powder having a water content of 1 to 50 percent by weight, based on total weight of the water-moist powder; and

F) mixing the water-moist powder of graft rubbers A) and B) with said rubber-free thermoplastic polymer resin C) in a kneader reactor,

wherein

a) the graft rubber components A) and B) are prepared in a single polymerization reaction,

b) the content in wt. % of the rubber originating from graft rubber component A) based on the total amount of rubber in the molding composition is 0 to 25 wt. %, preferably 2.5 to 20 wt. %, and particularly preferably 5 to 15 wt. % lower than the content of rubber in wt. % originating from graft rubber component B), in each case based on 100 parts by wt. of graft rubber, and

c) the average particle diameter d₅₀ of the total of all the rubber particles contained in the molding composition has a value of ≧300 nm, preferably ≧320 nm, and particularly preferably ≧340 nm.

The present invention also provides thermoplastic molding compositions of the ABS type obtainable by one of the processes according to the invention.

Unless otherwise indicated, all numbers or expressions, such as those expressing reaction conditions, quantities of ingredients, etc. used in the specification and claims are understood as modified in all instances by the term “about.”

As used herein and in the claims, the term “ABS compositions” (and similar terms, such as “compositions of the ABS type”) means compositions which comprise acrylonitrile, butadiene and styrene, and compositions in which these recited constituents have been replaced entirely or in part by analogous constituents. Examples of analogous constituents relative to acrylonitrile include, but are not limited to, methacrylonitrile, ethacrylonitrile, methyl methacrylate or N-phenylmaleimide. Examples of analogous constituents relative to styrene include, but are not limited to, α-methylstyrene, chlorostyrene, vinyltoluene, p-methylstyrene or tert-butylstyrene. An analogous constituent for butadiene includes, for example, isoprene.

### DETAILED DESCRIPTION OF THE INVENTION

Such products are suitable in particular for effective impact modification of thermoplastic resin systems. Suitable thermoplastic resin systems include, for example, those comprising vinyl homopolymers, such as, for example, polymethyl methacrylate or polyvinyl chloride, and, in particular, those comprising vinyl polymers which differ from the rubber-free thermoplastic polymer resins C) only by the molecular weight and/or the chemical composition (e.g. styrene/acrylonitrile copolymers with a molecular weight which differs from C) and/or an acrylonitrile content which deviates from C) and those comprising an aromatic polycarbonate, polyester-carbonate, polyester or polyamide.

The invention therefore also provides molding compositions comprising at least one molding composition of the ABS type obtainable by one of the processes according to the invention and furthermore at least one further polymer component chosen from aromatic polycarbonate, aromatic polyester-carbonate, polyester and polyamide.

In general, the molding compositions according to the invention can comprise the graft rubbers A) and B) and the rubber-free thermoplastic polymer resin C) in any desired amounts, as long as the abovementioned parameters are maintained.

The compositions conventionally comprise the graft rubbers A) and B) in the range from 5 to 95 parts by wt., preferably 20 to 75 parts by wt., and particularly preferably 25 to 70 parts by wt., and the rubber-free thermoplastic polymer resin C) in the range from 95 to 5 parts by wt., preferably 80 to 25 parts by wt., and particularly preferably 75 to 30 parts by wt. (total parts by weight of A), B) and CO being 100).

Polymers with a glass transition temperature of ≦0° C. are conventionally employed as the rubbers.

Examples of such polymers are butadiene polymers, such as e.g. polybutadiene or butadiene copolymers with up to 50 wt. % (based on the total amount of monomers employed for the preparation of the butadiene polymer) of one or more monomers which can be copolymerized with butadiene (e.g. isoprene, styrene, acrylonitrile, α-methylstyrene, C₁-C₄-alkylstyrenes, C₁-C₈-alkyl acrylates, C₁-C₈-alkyl methacrylates, alkylene glycol diacrylates, alkylene glycol dimethacrylates and divinylbenzene), polymers of C₁-C₈-alkyl acrylates or C₁-C₈-alkyl methacrylates, such as e.g. poly-(n-butyl acrylate) and poly-(2-ethylhexyl acrylate), and polydimethylsiloxanes.

Preferred rubbers are polybutadiene, butadiene/styrene copolymers with up to 20 wt. % of incorporated styrene and butadiene/acrylonitrile copolymers with up to 15 wt. % of incorporated acrylonitrile.

The rubbers to be employed according to the invention are conventionally prepared by emulsion polymerization. This polymerization is known and is described e.g. in Houben-Weyl, Methoden der Organischen Chemie, Makromolekulare Stoffe, part 1, p. 674 (1961), Thieme Verlag Stuttgart.

A specific variant which can also be used is the so-called seed polymerization technique, in which a finely divided butadiene polymer is first prepared and is then further polymerized to larger particles by further reaction with butadiene-containing monomers.

It is also possible first to prepare, by known methods, a finely divided rubber polymer, preferably a finely divided butadiene polymer, and then to agglomerate this in a known manner to establish the required particle diameter.

Relevant techniques are described (cf. EP-PS 0 029 613; EP-PS 0 007 810; DD-PS 144 415; DE-AS 12 33 131; DE-AS 12 58 076; DE-OS 21 01 650 and US-PS 1 379 391.

Emulsifiers which can be used in the synthesis of the rubber latices are the conventional anionic emulsifiers, such as alkyl sulfates, alkylsulfonates, aralkylsulfonates and soaps of saturated or unsaturated fatty acids and of alkaline disproportionated or hydrogenated abietic or tall oil acids, and emulsifiers with carboxyl groups (e.g. salts of C₁₀-C₁₈-fatty acids, disproportionated abietic acid, hydrogenated abietic acid and emulsifiers according to DE-A 3 639 904 and DE-A 3 913 509) are preferably employed.

In the preparation of graft rubbers A) and B) in separate polymerization reactions, the rubber latex employed for the preparation of graft rubber A) has an average particle diameter d₅₀ of <200 nm, preferably ≦190 nm, and particularly preferably ≦180 nm. In the case of joint preparation of graft rubbers A) and B) in one polymerization reaction, the rubber latex employed for the preparation of graft rubber A) has an average particle diameter d₅₀ of <300 nm, preferably ≦290 nm, and particularly preferably ≦280 nm.

In the case of preparation of graft rubbers A) and B) in separate polymerization reactions, the rubber latex employed for the preparation of graft rubber B) has an average particle diameter d₅₀ of ≧200 nm, preferably ≧210 nm, and particularly preferably ≧220 nm. In the case of joint preparation of graft rubbers A) and B) in one polymerization reaction, the rubber latex employed for the preparation of graft rubber B) has an average particle diameter d₅₀ of ≧300 nm, preferably ≧310 nm, and particularly preferably ≧320 nm.

The average particle diameter d₅₀ can be determined by ultracentrifuge measurement (cf. W. Scholtan, H. Lange: Kolloid Z.u.Z. Polymere 250, p. 782 to 796 (1972)).

The grafting polymerization in the preparation of graft rubbers A) and B) can be carried out by a procedure in which the monomer mixture is continuously added to the particular rubber latex and polymerized. Specific monomer:rubber ratios are preferably maintained here, and the monomers are added to the rubber latex in a known manner.

To produce the graft rubber components A) and B), 25 to 70 parts by wt., particularly preferably 30 to 60 parts by wt. of a mixture of at least two monomers chosen from styrene, α-methylstyrene, acrylonitrile, methacrylonitrile, methyl methacrylate and N-phenylmaleimide are preferably polymerized in the presence of preferably 30 to 75 parts by wt., particularly preferably 40 to 70 parts by wt. (in each case based on the solids) of the rubber latex.

The monomers employed in these grafting polymerization reactions are preferably mixtures of styrene and acrylonitrile in a wt. ratio of 90:10 to 50:50, particularly preferably in a wt. ratio of 65:35 to 75:25.

Molecular weight regulators can additionally be employed in the grafting polymerization, preferably in amounts of 0.05 to 2 wt. %, particularly preferably in amounts of 0.1 to 1 wt. % (in each case based on the total amount of monomer in the grafting polymerization stage).

Suitable molecular weight regulators are, for example, alkylmercaptans, such as n-dodecylmercaptan and t-dodecylmercaptan; dimeric α-methylstyrene; and terpinolene.

Possible initiators are inorganic and organic peroxides, e.g. H₂O₂, di-tert-butyl peroxide, cumene hydroperoxide, dicyclohexyl percarbonate, tert-butyl hydroperoxide and p-menthane hydroperoxide, azo initiators, such as azobisisobutyronitrile, inorganic per-salts, such as ammonium, sodium or potassium persulfate, potassium perphosphate and sodium perborate, and redox systems. Redox systems as a rule comprise an organic oxidizing agent and a reducing agent, it being possible for heavy metal ions additionally to be present in the reaction medium (see Houben-Weyl, Methoden der Organischen Chemie, volume 14/1, p. 263 to 297).

The polymerization temperature is 25° C. to 160° C., preferably 40° C. to 90° C. Suitable emulsifiers are the conventional anionic emulsifiers, such as alkyl sulfates, alkylsulfonates, aralkylsulfonates and soaps of saturated or unsaturated fatty acids and alkaline disproportionated or hydrogenated abietic or tall oil acids. Emulsifiers with carboxyl groups (e.g. salts of C₁₀-C₁₈-fatty acids, disproportionated abietic acid, hydrogenated abietic acid and emulsifiers according to DE-A 36 39 904 and DE-A 39 13 509) are preferably employed.

Products obtained by free-radical polymerization of at least two monomers chosen from styrene, α-methylstyrene, acrylonitrile, methacrylonitrile, methyl methacrylate and N-phenylmaleimide are employed as the rubber-free thermoplastic polymer resins C).

Preferred polymer resins C) are copolymers of styrene and acrylonitrile in a weight ratio of 90:10 to 50:50, particularly preferably in a weight ratio of 80:20 to 65:35.

The polymer resins C) preferably have average molecular weights \overline{M}_{w} of 20,000 to 200,000 or limiting viscosities [η] of 20 to 110 ml/g (measured in dimethylformamide at 25° C.). Such resins are known and can be prepared by free-radical polymerization, e.g. in emulsion, suspension, solution or bulk. Details of the preparation of these resins are described, for example, in DE-AS 2 420 358 and DE-AS 2 724 360. Resins prepared by bulk or solution polymerization have proved to be particularly suitable.

Mixing of components A), B) and C) is carried out in a kneader reactor as described, for example, in EP-A 867 463. For this, the graft rubbers A) and B) precipitated from the latex form are dewatered to a residual moisture content of 1 to 50 wt. %, preferably 5 to 50 wt. %, particularly preferably 10 to 40 wt. %, and incorporated in the form of a water-moist powder into the melt of the rubber-free thermoplastic polymer resin C) in a large-volume kneader reactor.

During this procedure, evaporation of the process water adhering to the graft polymers, melting of the graft polymers, blending of the graft polymers with the melt of the rubber-free thermoplastic polymer resin and removal of volatile organic constituents take place simultaneously in one process space.

The dewatering of the precipitated graft rubbers is preferably carried out mechanically, e.g. by pressing off or centrifugation.

The energy necessary for melting, heating and devolatilizing the polymer mixture is introduced mechanically via the kneading action of the rotors and thermally via the housing surfaces of the kneader reactor, the ratio between the mechanical and thermal energy to be introduced into the mixture preferably being 4:1 to 1:6, particularly preferably 2.5:1 to 1:4.

The process is preferably carried out in a large-volume, partly filled kneader reactor with rotating inserts, in which the throughput of polymer per litre of process space is not more than 5 kg/h. The residence time of the mixture in the process space is typically 2 to 20 minutes.

Kneader reactors which control mixing of viscoplastic phases, for example those which are known from the specifications EP 0 517 068 A1, EP 460 466 B1, EP 0 528 210 A1 or JP-A-63-232828, are suitable for carrying out the process according to the invention. Twin-shaft reactors according to EP 0 517 068 A1 are preferably employed. Since under certain circumstances the mechanical stress on the rotors and the drive power required are considerably greater than during conventional uses of this class of apparatus, it may be necessary to reinforce the rotors of commercially available apparatuses and to choose a considerably more powerful drive compared with conventional equipment.

In a preferred embodiment, the water-moist graft polymers are fed in by means of a stuffing screw or a ram sluice. The graft polymers can furthermore be fed in via a strainer or pressing-off screw with partial mechanical removal of the moisture. In the preferred embodiment, the melt of the rubber-free thermoplastic polymer resin is fed in via the front plate of the kneader reactor on the intake side. This prevents the graft polymers, which are as a rule heat-sensitive, from coming into contact with the hot housing surfaces. Rather, the graft polymers are embedded in the melt of the rubber-free thermoplastic polymer resins immediately on entry into the large-volume kneader reactor. Impairment of the mixed product by possible by-products due to a longer educt residence time at the start of the kneader reactor is moreover avoided.

The dewatered, degassed and compounded ABS composition is preferably discharged from the kneader reactor via a discharge screw or gear pump at or close to the front plate opposite the feed. The reactor volume is used to the optimum by this arrangement. Sieving of the melt and granulation can be coupled to the discharge organ by methods known to the skilled artisan.

The vapours are drawn off via a degassing opening, which is preferably arranged close to the product discharge, and are then condensed in a manner known in principle. In the case of an arrangement of the degassing opening closer to the feeding-in point, the risk that the yield is reduced due to powder fly increases. In the preferred embodiment, the degassing opening is furthermore cleaned by a screw. This prevents the melt from entering in to the vapour channel and causing blockages.

In the preferred embodiment, all the surfaces of the kneader reactor which come into contact with the product are furthermore heated. As a result, the energy supply into the process space is maximized, so that the process can be operated to the economic optimum.

The process is conventionally carried out under an internal pressure of 1 hPa to 5,000 hPa, in particular 10 to 2,000 hPa, but preferably under normal pressure, optionally also with the addition of inert gases. The temperature of the heating of the apparatus wall is 150 to 350° C., preferably 180 to 300° C., particularly preferably 200 to 270° C. The specific drive power for a reactor with rotating inserts is 0.01 to 1 kWh per kg of dry polymer melt, preferably 0.05 to 0.5 kWh/kg, and particularly preferably 0.05 to 0.25 kWh/kg.

The molding compositions of the ABS type prepared according to the invention can be mixed with further polymer components, preferably chosen from aromatic polycarbonate, aromatic polyester-carbonate, polyester and polyamide.

Suitable thermoplastic polycarbonates and polyester-carbonates are known (cf. e.g. DE-A 14 95 626, DE-A 22 32 877, DE-A 27 03 376, DE-A 27 14 544, DE-A 30 00 610, DE-A 38 32 396 and DE-A 30 77 934) and can be prepared, for example, by reaction of diphenols of the formulae (IV) and (V)

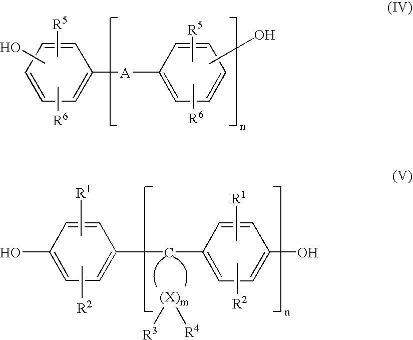

wherein

A is a single bond, C₁-C₅-alkylene, C₂-C₅-alkylidene, C₅-C₆-cycloalkylidene,

—O—, —S—, —SO—, —SO₂— or —CO—,

R⁵ and R⁶ independently of one another represent hydrogen, methyl or halogen, in particular hydrogen, methyl, chlorine or bromine,

R¹ and R² independently of one another denote hydrogen, halogen, preferably chlorine or bromine, C₁-C₈-alkyl, preferably methyl or ethyl, C₅-C₆-cycloalkyl, preferably cyclohexyl, C₆-C₁₀-aryl, preferably phenyl, or C₇-C₁₂-aralkyl, preferably phenyl-C₁-C4-alkyl, in particular benzyl,

m is an integer from 4 to 7, preferably 4 or 5,

n is 0 or 1,

R³ and R⁴ can be chosen individually for each X and independently of one another denote hydrogen or C₁-C₆-alkyl and

X denotes carbon,

with carbonic acid halides, preferably phosgene, and/or with aromatic dicarboxylic acid dihalides, preferably benzenedicarboxylic acid dihalides, by interfacial polycondensation or with phosgene by polycondensation in a homogeneous phase (the so-called pyridine process), it being possible for the molecular weight to be established in a known manner by a corresponding amount of known chain terminators.

Suitable diphenols of the formulae (IV) and (V) are e.g. hydroquinone, resorcinol, 4,4′-dihydroxydiphenyl, 2,2-bis-(4-hydroxyphenyl)-propane, 2,4-bis-(4-hydroxyphenyl)-2-methylbutane, 2,2-bis-(4-hydroxy-3,5-dimethylphenyl)-propane, 2,2-bis-(4-hydroxy-3,5-dichlorophenyl)-propane, 2,2-bis-(4-hydroxy-3,5-dibromophenyl)-propane, 1,1-bis-(4-hydroxyphenyl)-cyclohexane, 1,1-bis-(4-hydroxyphenyl)-3,3,5-trimethylcyclohexane, 1,1-bis-(4-hydroxyphenyl)-3,3-dimethylcyclohexane, 1,1-bis-(4-hydroxyphenyl)-3,3,5,5-tetramethylcyclohexane or 1,1-bis-(4-hydroxyphenyl)-2,4,4-trimethylcyclopentane.

Preferred diphenols of the formula (IV) are 2,2-bis-(4-hydroxyphenyl)-propane and 1,1-bis-(4-hydroxyphenyl)-cyclohexane, and the preferred phenol of the formula (V) is 1,1-bis-(4-hydroxyphenyl)-3,3,5-trimethylcyclohexane.

Mixtures of diphenols can also be employed.

Suitable chain terminators are e.g. phenol, p-tert-butylphenol, long-chain alkylphenols, such as 4-(1,3-tetramethyl-butyl)phenol according to DE-A 2 842 005, and monoalkylphenols and dialkylphenols having a total of 8 to 20 C atoms in the alkyl substituents according to DE-A 3 506 472, such as p-nonylphenol, 2,5-di-tert-butylphenol, p-tert-octylphenol, p-dodecylphenol, 2-(3,5-dimethylheptyl)-phenol and 4-(3,5-dimethylheptyl)-phenol. The amount of chain terminators required is in general 0.5 to 10 mol %, based on the sum of the diphenols (IV) and (V).

The suitable polycarbonates or polyester-carbonates can be linear or branched; branched products are preferably obtained by incorporation of 0.05 to 2.0 mol %, based on the sum of the diphenols employed, of compounds which are trifunctional or more than trifunctional, e.g. those having three or more than three phenolic OH groups.

The suitable polycarbonates and polyester-carbonates can contain aromatically bonded halogens, preferably bromine and/or chlorine; they are preferably halogen-free.

They have average molecular weights (\overline{M}_{w}, weight-average), determined e.g. by ultracentrifugation or scattered light measurement, of 10,000 to 200,000, preferably 20,000 to 80,000.

Suitable thermoplastic polyesters are preferably polyalkylene terephthalates, i.e. reaction products of aromatic dicarboxylic acids or their reactive derivatives (e.g. dimethyl esters or anhydrides) and aliphatic, cycloaliphatic or arylaliphatic diols and mixtures of such reaction products.

Preferred polyalkylene terephthalates can be prepared from terephthalic acids (or their reactive derivatives) and aliphatic or cycloaliphatic diols having 2 to 10 C atoms by known methods (Kunststoff-Handbuch, volume VIII, p. 695 et seq., Carl Hanser Verlag, Munich 1973).

In preferred polyalkylene terephthalates, 80 to 100, preferably 90 to 100 mol % of the dicarboxylic acid radicals are terephthalic acid radicals and 80 to 100, preferably 90 to 100 mol % of the diol radicals are ethylene glycol radicals and/or butane-1,4-diol radicals.

In addition to ethylene glycol radicals or butane-1,4-diol radicals, the preferred polyalkylene terephthalates can contain 0 to 20 mol % of radicals of other aliphatic diols having 3 to 12 C atoms or cycloaliphatic diols having 6 to 12 C atoms, e.g. radicals of propane-1,3-diol, 2-ethylpropane-1,3-diol, neopentylglycol, pentane-1,5-diol, hexane1,6-diol, cyclohexane-1,4-dimethanol, 3-methylpentane-1,3-diol and -1,6-diol, 2-ethylhexane-1,3-diol, 2,2-diethylpropane-1,3-diol, hexane-2,5-diol, 1,4-di(β-hydroxyethoxy)-benzene, 2,2-bis-(4-hydroxycyclohexyl)-propane, 2,4-dihydroxy-1,1,3,3-tetramethylcyclobutane, 2,2-bis-(3-β-hydroxyethoxyphenyl)-propane and 2,2-bis-(4-hydroxypropoxyphenyl)-propane (DE-A 2 407 647, 2 407 776 and 2 715 932).

The polyalkylene terephthalates can be branched by incorporation of relatively small amounts of 3- or 4-hydric alcohols or 3- or 4-basic carboxylic acids, such as are described in DE-A 1 900 270 and US-A 3 692 744. Examples of preferred branching agents are trimesic acid, trimellitic acid, trimethylolethane and -propane and pentaerythritol. It is advisable to use not more than 1 mol % of the branching agent, based on the acid component.

Polyalkylene terephthalates which have been prepared solely from terephthalic acid and reactive derivatives thereof (e.g. dialkyl esters thereof) and ethylene glycol and/or butane-1,4-diol and mixtures of these polyalkylene terephthalates are particularly preferred.

Preferred polyalkylene terephthalates are also copolyesters which are prepared from at least two of the abovementioned alcohol components; particularly preferred copolyesters are poly-(ethylene glycol/butane-1,4-diol) terephthalates.

The polyalkylene terephthalates which are preferably suitable in general have an intrinsic viscosity of 0.4 to 1.5 dl/g, preferably 0.5 to 1.3 dl/g, in particular 0.6 to 1.2 dl/g, in each case measured in phenol/o-dichloro-benzene (1:1 parts by wt.) at 25° C.

Suitable polyamides are known homopolyamides, copolyamides and mixtures of these polyamides. These can be partly crystalline and/or amorphous polyamides.

Suitable partly crystalline polyamides are polyamide 6, polyamide 6,6 and mixtures and corresponding copolymers of these components. Partly crystalline polyamides in which the acid component comprises entirely or partly terephthalic acid and/or isophthalic acid and/or suberic acid and/or sebacic acid and/or azelaic acid and/or adipic acid and/or cyclohexane-dicarboxylic acid, the diamine component comprises entirely or partly m- and/or p-xylylenediamine and/or hexamethylenediamine and/or 2,2,4-trimethylhexamethylenediamine and/or 2,2,4-trimethylhexamethylenediamine and/or isophoronediamine and the composition of which is known in principle are furthermore possible.

Polyamides which are prepared entirely or in part from lactams having 7-12 C atoms in the ring optionally with the co-use of one or more of the abovementioned starting components, are furthermore to be mentioned.

Particularly preferred partly crystalline polyamides are polyamide 6 and polyamide 6,6 and their mixtures. Known products can be employed as amorphous polyamides. They are obtained by polycondensation of diamines, such as ethylenediamine, hexamethylenediamine, decam-ethylenediamine, 2,2,4- and/or 2,4,4-trimethylhexamethylene-diamine, m- and/or p-xylylenediamine, bis-(4-aminocyclohexyl)-methane, bis-(4-aminocyclohexyl)-propane, 3,3′-dimethyl-4,4′-diamino-dicyclohexylmethane, 3-aminomethyl-3,5,5-trimethylcyclohexylamine, 2,5- and/or 2,6-bis-(aminomethyl)-norbornane and/or 1,4-diaminomethylcyclo-hexane, with dicarboxylic acids, such as oxalic acid, adipic acid, azelaic acid, decanedicarboxylic acid, heptadecanedicarboxylic acid, 2,2,4- and/or 2,4,4-trimethyladipic acid, isophthalic acid and terephthalic acid.

Copolymers which are obtained by polycondensation of several monomers are also suitable, and furthermore copolymers which are prepared with the addition of aminocarboxylic acids, such as ε-aminocaproic acid, ω-amino-undecanoic acid and ω-aminolauric acid, or their lactams.

Particularly suitable amorphous polyamides are the polyamides prepared from isophthalic acid, hexamethylenediamine and further diamines, such as 4,4′-diaminodicyclohexylmethane, isophoronediamine, 2,2,4- and/or 2,4,4-trimethylhexamethylenediamine and 2,5- and/or 2,6-bis-(aminomethyl)-norbornene; or from isophthalic acid, 4,4′-diamino-dicyclohexylmethane and ε-caprolactam; or from isophthalic acid, 3,3′-dimethyl-4,4′-diamino-dicyclohexylmethane and lauryllactam; or from terephthalic acid and the isomer mixture of 2,2,4- and 2,4,4-trimehtyl-hexamethylenediamine.

Instead of pure 4,4′-diaminodicyclohexylmethane, it is also possible to employ mixtures of the position isomers of diaminodicyclohexylmethane which are composed of 70 to 99 mol % of the 4,4′-diamino isomer, 1 to 30 mol % of the 2,4′-diamino isomer and 0 to 2 mol % of the 2,2′-diamino isomer and optionally correspondingly more highly condensed diamines, which are obtained by hydrogenation of diaminodiphenylmethane of technical-grade quality. The isophthalic acids can be replaced by terephthalic acid to the extent of up to 30 wt. %.

The polyamides preferably have a relative viscosity (measured on a 1 wt. % solution in m-cresol at 25° C.) of 2.0 to 5.0, particularly preferably 2.5 to 4.0.

Mixing of the molding compositions of the ABS type according to the invention with further polymers and optionally conventional additives is carried out on conventional mixing units, preferably on multiple-roll mills, mixing extruders or internal kneaders.

In accordance with the present invention, there is provided a method of preparing a molded article comprising: (a) providing a molding composition of the ABS type prepared in accordance with the present invention; and (b) introducing the composition of the ABS type into a mold, for example by means of injection molding. After removal from the mold, the molded article may optionally be further processed, for example, polished, tinted and/or coated.

The molding compositions according to the invention are suitable for the production of all types of molded articles, including, for example, housing components, covers, sheets etc.

The invention furthermore provides the use of the molding compositions according to the invention for the production of moldings and the moldings themselves.

### EXAMPLES

The invention is explained in more detail in the following examples. Unless otherwise noted, the parts stated are parts by weight and always relate to solid constituents or polymerizable constituents.

Components employed:

Graft rubber A1:

Graft rubber latex obtained by free-radical polymerization of 50 parts by wt. of a styrene/acrylonitrile=73:27 mixture in the presence of 50 parts by wt. (solid) of a polybutadiene latex with an average particle diameter d₅₀ of 128 nm using 0.5 part by wt. of K₂S₂O₈ as the initiator.

Graft rubber B1:

Graft rubber latex obtained by free-radical polymerization of 42 parts by wt. of a styrene/acrylonitrile=73:27 mixture in the presence of 58 parts by wt. (solid) of a polybutadiene latex with an average particle diameter d₅₀ of 352 nm using 0.5 part by wt. of K₂S₂O₈ as the initiator.

Graft rubber mixture A2/B2-1

Graft rubber latex obtained by free-radical polymerization of 40 parts by wt. of a styrene/acrylonitrile=73:27 mixture in the presence of 60 parts by wt. (solid) of a mixture of a polybutadiene latex with an average particle diameter d₅₀ of 274 nm (45%) and a polybutadiene latex with an average particle diameter d₅₀ of 408 nm (55%), a redox system of sodium ascorbate and tert-butyl hydroperoxide having been used as the initiator.

Graft rubber mixture A2/B2-2

Graft rubber latex obtained analogously to graft rubber mixture A2/B2-1, but using a mixture of 55% of a polybutadiene latex with an average particle diameter d₅₀ of 274 nm and 45% of a polybutadiene latex with an average particle diameter d₅₀ of 408 nm.

Polymer resin C

Random styrene/acrylonitrile copolymer (styrene:acrylonitrile wt. ratio 72:28) with an \overline{M}_{w} of approx. 85,000 and \overline{M}_{w}/\overline{M}ₙ-1≦2 obtained by free-radical solution polymerization.

Polycarbonate Resin as a Further Polymer Resin Component

Linear aromatic polycarbonate from 2,2-bis-(4-hydroxyphenyl)-propane (bisphenol A) with a relative viscosity of 1.26 (measured in CH₂Cl₂ at 25° C. in the form of a 0.5 wt. % solution), corresponding to an \overline{M}_{w} of approx. 25,000.

The graft rubber latices A1 and B1 were mixed in the ratio (based on the solid) stated in table 1 or the graft rubber latices A2/B2-1 and A2/B2-2 were employed without prior mixing and then coagulated using a magnesium sulfate/acetic acid=1:1 mixture, washed with water and, after centrifugation according to example 1 of EP-A 867 463, the moist powder was mixed with the melt of polymer resin C in a kneader reactor.

In parallel with this, the moist powders of the coagulated mixed graft rubber latices A1 and B1 and of the coagulated graft rubber latex A2/B2-1 and of the coagulated graft rubber latex A2/B2-1 and of the coagulated graft rubber latex A2/B2-1 were dried in a circulating air drying cabinet at 70° C.

Both the products from A1, B1 and C resulting after mixing in the kneader reactor and the powders A1 and B1 dried in the circulating air drying cabinet were compounded with further styrene/acrylonitrile copolymer (polymer resin C) in an internal kneader to give products with a rubber content of in each case 16 wt. %, 2 parts by wt. of ethylenediamine-bisstearylamide and 0.1 part by wt. of a silicone oil having been added as additives (in each case based on 100 parts by wt. of polymer).

From the resulting compounds, test specimens were injection-molded at 240° C., on which the notched impact strength was determined at room temperature (aₖ^{RT}) and at −40° C. (aₖ^{-40° C.}) in accordance with ISO 180/1A (unit: kJ/m²).

Both the products from A2/B2-1 and C and from A2/B2-2 and C resulting after mixing in the kneader reactor and the powders A2/B2-1 and A2/B2-2 dried in the circulating air drying cabinet were furthermore compounded with further styrene/acrylonitrile copolymer (polymer resin C) and the polycarbonate resin described above in an internal kneader in each case to give products with a graft rubber content of 24 wt. %, a content of styrene/acrylonitrile copolymer C of 33 wt. % and a content of polycarbonate resin of 43 wt. %, in each case 0.75 part by wt. of pentaerythritol tetrastearate having been added as an additive (based on 100 parts by wt. of polymer).

From the resulting compounds, test specimens were injection-molded at 260° C., on which the notched impact strength was determined at −20° C. (aₖ⁻²⁰° C.) in accordance with ISO 180/1A (unit: kJ/m²).

From the toughness values also stated in table 1, it can be seen that the products prepared in the kneader reactor have toughness properties comparable to the products prepared using graft rubber powder only if the parameters according to the invention are maintained.

If the parameters according to the invention are not maintained, however, a significant drop in the notched impact strength of the products prepared in the kneader reactor is observed.

TABLE 1
Graft rubbers employed and properties of the molding compositions tested

| | A1 | B1 | Δ rubber B/A | Working up via | | Working up via | |
|---|---|---|---|---|---|---|---|
| | (parts | (parts | [%] (based on | a kneader reactor | | the graft rubber | |
| | by | by | 100 parts by wt. | (melt) aₖ^{RT} (kJ/m²) | | powder aₖ^{RT} (kJ/m²) | |
| Example | wt.) | wt.) | of graft rubber) | aₖ^{-40° C.} (kJ/m²) | | aₖ^{-40° C.} (kJ/m²) | |
| 1 | 40 | 60 | 14.8 | 17.5 | 9.6 | 17.6 | 9.5 |
| 2 | 45 | 55 | 9.4 | 16.8 | 9.1 | 17.0 | 9.2 |
| 3 (comparison) | 50 | 50 | 4.0 | 14.2 | 7.4 | 16.5 | 8.7 |
| 4 (comparison) | 55 | 45 | −1.4 | 13.0 | 6.9 | 15.6 | 8.2 |
| 5 (comparison) | 60 | 40 | −6.8 | 11.6 | 6.5 | 15.1 | 8.1 |

| | | | ΔRubber B/A | Working up | Working up |
|---|---|---|---|---|---|
| | A2/B2-1 | A2/B2-2 | [%] (based on | via a kneader | via the graft |
| | (parts by | (parts by | 100 parts by wt. | reactor (melt) | rubber powder |
| Example | wt.) | wt.) | of graft rubber) | aₖ^{-20° C.} (kJ/m²) | aₖ^{-20° C.} (kJ/m²) |
| 6 | 100 | — | 10 | 83 | 86 |
| 7 (comparison) | — | 100 | −10 | 44 | 78 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process of preparing a thermoplastic molding composition of the ABS type comprising:
A) forming at least one graft rubber A) by emulsion polymerization of,
(i) at least two monomers selected from the group consisting of styrene, α-methylstyrene, acrylonitrile, methacrylonitrile, methyl methacrylate and N-phenylmaleimide,
in the presence of,
(ii) at least one rubber latex, the average particle diameter d₅₀ of the rubber latex being <200 nm;
B) forming at least one graft rubber B) by emulsion polymerization of,
(i) at least two monomers selected from the group consisting of styrene, α-methylstyrene, acrylonitrile, methacrylonitrile, methyl methacrylate and N-phenylmaleimide,
in the presence of
(ii) at least one rubber latex, the average particle diameter d₅₀ of the rubber latex being ≧200 nm;
C) forming at least one rubber-free thermoplastic polymer resin C) by free-radical polymerization of at least two monomers selected from the group consisting of styrene, α-methylstyrene, acrylonitrile, methacrylonitrile, methyl methacrylate and N-phenylmaleimide;
D) forming precipitates of each of graft rubbers A) and B);
E) dewatering the precipitates of graft rubbers A) and B) to form water-moist powders of graft rubbers A) and B), each water-moist powder independently having a water content of 1 to 50 percent by weight, based on total weight of the water-moist powder; and
F) mixing the water-moist powders of graft rubbers A) and B) with said rubber-free thermoplastic polymer resin C) in a kneader reactor,
wherein
a) the graft rubber components A) and B) are each prepared in separate emulsion polymerization reactions,
b) the content in wt. % of rubber originating from graft rubber component A) based on the total amount of rubber in the molding composition is at least 5 wt. % lower than the content of rubber in wt. % originating from graft rubber component B), in each case based on 100 parts by wt. of graft rubber, and
c) the average particle diameter d₅₀ of all rubber particles contained in the molding composition is ≦300 nm.

2. The process of claim 1 wherein the content in wt. % of the rubber originating from graft rubber component A) based on the total amount of rubber in the molding composition is at least 7.5 wt. % lower than the content of rubber in wt. % originating from graft rubber component B), in each case based on 100 parts by wt. of graft rubber.

3. The process of claim 1 wherein the average particle diameter d₅₀ of all rubber particles contained in the molding composition is ≦280 nm.

4. The molding composition prepared by the process of claim 1.

5. A process for preparing a thermoplastic molding composition of the ABS type comprising:
A) forming at least one graft rubber by emulsion polymerization of,
(i) at least two monomers selected from the group consisting of styrene, α-methylstyrene, acrylonitrile, methacrylonitrile, methyl methacrylate and N-phenylmaleimide,
in the presence of
(ii) at least one rubber latex, the average particle diameter d₅₀ of the rubber latex being <300 nm;
B) forming at least one graft rubber by emulsion polymerization of,
(i) at least two monomers selected from the group consisting of styrene, α-methylstyrene, acrylonitrile, methacrylonitrile, methyl methacrylate and N-phenylmaleimide,
in the presence of
(ii) at least one rubber latex, the average particle diameter d₅₀ of the rubber latex being ≧300 nm;
C) forming at least one rubber-free thermoplastic polymer resin by free-radical polymerization of at least two monomers selected from the group consisting of styrene, α-methylstyrene, acrylonitrile, methacrylonitrile, methyl methacrylate and N-phenylmaleimide;
D) forming precipitates of graft rubbers A) and B);
E) dewatering the precipitates of graft rubbers A) and B) to form a water-moist powder of graft rubbers A) and B), said water-moist powder having a water content of 1 to 50 percent by weight, based on total weight of the water-moist powder; and
F) mixing the water-moist powder of graft rubbers A) and B) with said rubber-free thermoplastic polymer resin C) in a kneader reactor,
wherein
a) the graft rubber components A) and B) are prepared in a single polymerization reaction,
b) the content in wt. % of the rubber originating from graft rubber component A) based on the total amount of rubber in the molding composition is 0 to 25 wt. % lower than the content of rubber in wt. % originating from graft rubber component B), in each case based on 100 parts by wt. of graft rubber, and
c) the average particle diameter d₅₀ of all rubber particles contained in the molding composition is ≧300 nm.

6. The process of claim 5 wherein the content in wt. % of the rubber originating from graft rubber component A) based on the total amount of rubber in the molding composition is 2.5 to 20 wt. % lower than the content of rubber in wt. % originating from graft rubber component B), in each case based on 100 parts by wt. of graft rubber.

7. The process of claim 5 wherein the average particle diameter d₅₀ of all rubber particles contained in the molding composition is ≧320 nm.

8. The molding composition prepared by the process of claim 5.

9. The molding composition of claim 4 further comprising at least one polymer component selected from the group consisting of aromatic polycarbonate, aromatic polyester-carbonate, polyester, polyamide, vinyl homopolymer and vinyl copolymer.

10. The molding composition of claim 8 further comprising at least one polymer component selected from the group consisting of aromatic polycarbonate, aromatic polyester-carbonate, polyester, polyamide, vinyl homopolymer and vinyl copolymer.

11. A method of preparing a molded article comprising:
(a) providing the molding composition of claim 4; and
(b) introducing said composition into a mold.

12. The molded article of claim 11.

13. A method of preparing a molded article comprising:
(a) providing the molding composition of claim 8; and
(b) introducing said composition into a mold.

14. The molded article of claim 13.
